(19) United States
(12) Patent Application Publication
(10) Pub. No.: US 2023/0024791 A1
(43) Pub. Date: Jan. 26, 2023

(54) Monitor Speaker Assembly

(71) Applicant: Donn Roberts, West Terre Haute, IN (US)

(72) Inventor: Donn Roberts, West Terre Haute, IN (US)

(21) Appl. No.: 17/380,710

(22) Filed: Jul. 20, 2021

(51) Int. Cl. H04R 1/02; H04R 1/32; H04R 3/00

(52) U.S. Cl. CPC H04R 1/025; H04R 1/023; H04R 1/026; H04R 1/323; H04R 3/00

(57) ABSTRACT

A monitor speaker assembly for includes a drum shell. A plurality of first lugs is each of the first lugs is coupled to the drum shell. A mesh screen is attachable to the drum shell and the mesh screen is comprised of a fluid permeable material to pass sound through the mesh screen. A speaker is disposed within the drum shell to emit audible sounds outwardly from the drum shell. A receiver is coupled to the drum shell and a tripod is insertable into the receiver on the drum shell thereby facilitating the drum shell to elevated. In this way the drum shell can direct the speaker toward a drummer thereby facilitating the drummer to hear audible sounds emitted by the speaker.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### Field of the Invention

The disclosure relates to speaker devices and more particularly pertains to a new speaker device for facilitating a monitor for a drummer in a live musical performance to have the ornamental appearance of a drum. The device includes a drum shell and a mesh screen that is positioned on the drum shell. A speaker is positioned within the drum shell and the speaker emits audible sound from an audio source. In this way the speaker facilitates a drummer to hear a monitor signal for vocals or amplified instruments.

### Description of Related Art Including Information Disclosed Under 37 CFR 1.97 And 1.98.

The prior art relates to speaker devices including a variety of electronic speakers that are mounted in a tubular housing. The prior art discloses a variety of electronically amplified bass drums for enhancing sound produced by the bass drum. The prior art discloses a resonant speaker cone device that is mounted in a drum shell to improve acoustic properties of the drum shell. The prior art discloses an ornamental design of an electronic speaker having the appearance of a drum.

### BRIEF SUMMARY OF THE INVENTION

An embodiment of the disclosure meets the needs presented above by generally comprising a drum shell. A plurality of first lugs is each of the first lugs is coupled to the drum shell. A mesh screen is attachable to the drum shell and the mesh screen is comprised of a fluid permeable material to pass sound through the mesh screen. A speaker is disposed within the drum shell to emit audible sounds outwardly from the drum shell. A receiver is coupled to the drum shell and a tripod is insertable into the receiver on the drum shell thereby facilitating the drum shell to elevated. In this way the drum shell can direct the speaker toward a drummer thereby facilitating the drummer to hear audible sounds emitted by the speaker.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S

The disclosure will be better understood and objects other than those set forth above will become apparent when consideration is given to the following detailed description thereof. Such description makes reference to the annexed drawings wherein:

FIG. 1 is a front perspective view of a monitor speaker assembly according to an embodiment of the disclosure.

FIG. 2 is a front view of an embodiment of the disclosure.

FIG. 3 is a back view of an embodiment of the disclosure.

FIG. 4 is a cross sectional view taken along line 4-4 of FIG. 2 of an embodiment of the disclosure.

FIG. 5 is a cross sectional view taken along line 5-5 of FIG. 2 of an embodiment of the disclosure.

FIG. 6 is a perspective in-use view of an embodiment of the disclosure.

### DETAILED DESCRIPTION OF THE INVENTION

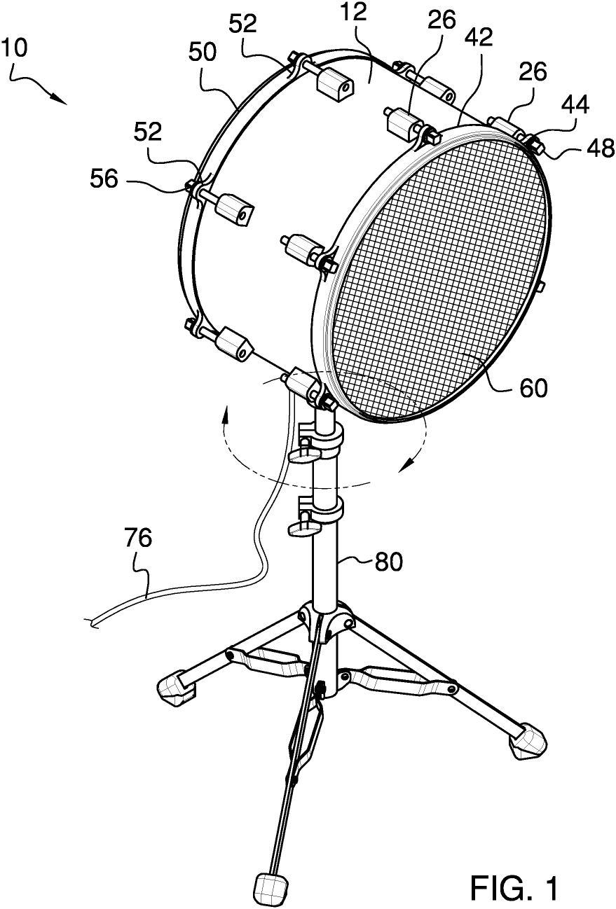

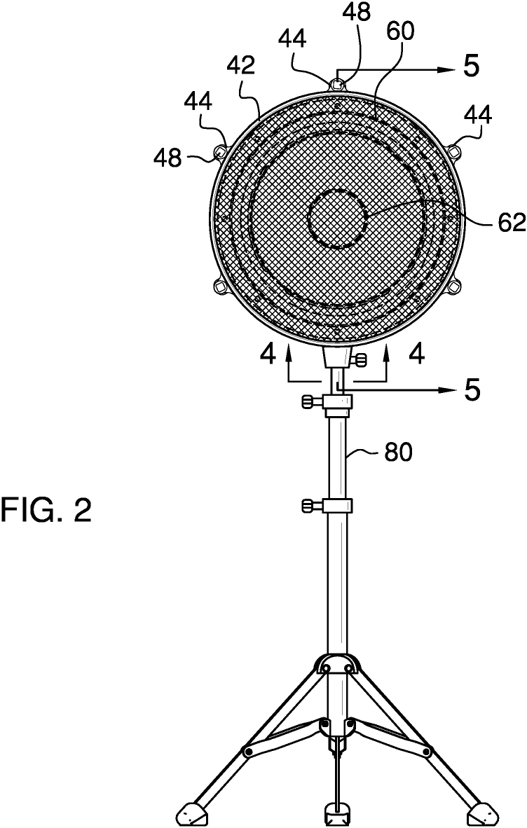

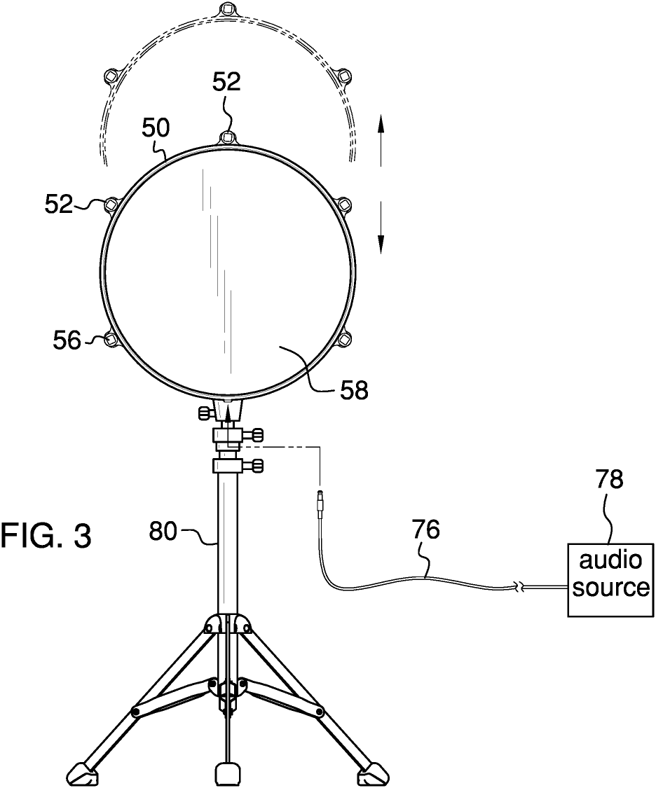

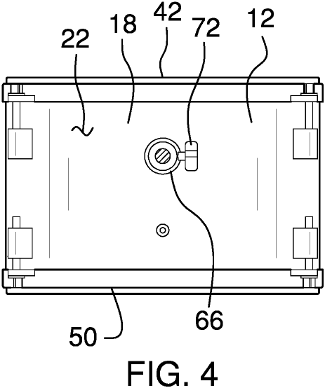

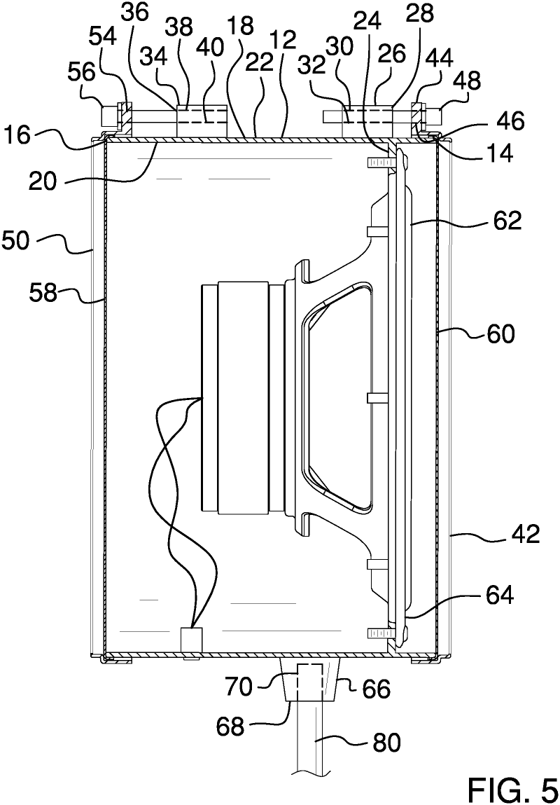

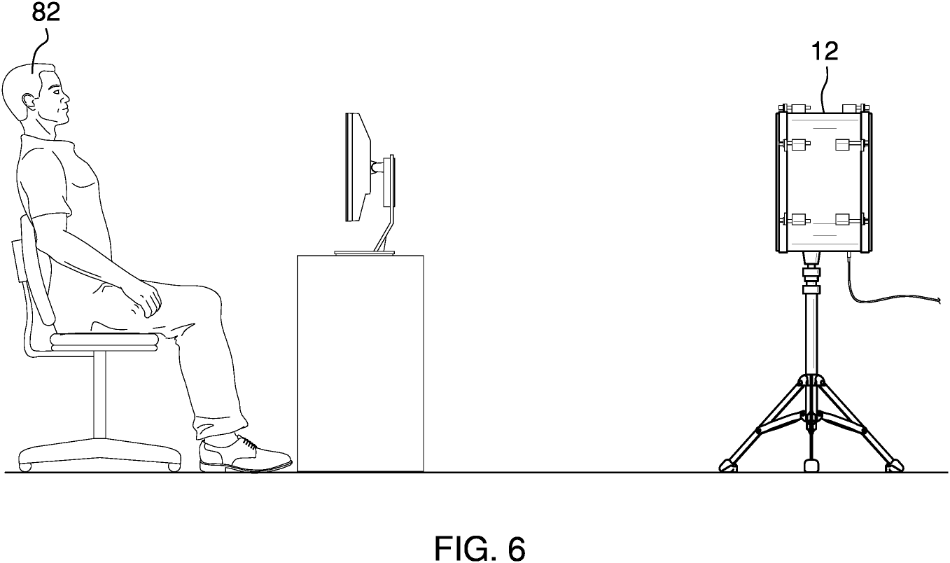

With reference now to the drawings, and in particular to FIGS. 1 through 6 thereof, a new speaker device embodying the principles and concepts of an embodiment of the disclosure and generally designated by the reference numeral 10 will be described.

As best illustrated in FIGS. 1 through 6, the monitor speaker assembly 10 generally comprises a drum shell 12 that has a first edge 14, a second edge 16 and an outer wall 18 extending between the first edge 14 and the second edge 16. The outer wall 18 is continuously arcuate about a center point of the drum shell 12 such that the drum shell 12 has a cylindrical shape. The outer wall 18 has an inside surface 20 and an outside surface 22, and the outer wall 18 has a lip 24 extending inwardly from the inside surface 20. Furthermore, the lip 24 extends around a full circumference of the outer wall 18 and the lip 24 is positioned adjacent to the first edge 14. The drum shell 12 may have a diameter ranging between approximately 15.0 inches and 20.0 inches such that the drum shell 12 has the ornamental appearance of a riser tom or other drum commonly employed on a multiple piece, stage drum set.

A plurality of first lugs 26 is each coupled to the drum shell 12 and each of the first lugs 26 is positioned on the outside surface 22 of the outer wall 18. The first lugs 26 are spaced apart from each other and are distributed around the outer wall 18. Each of the first lugs 26 is positioned closer to the first edge 14 than the second edge 16 and each of the first lugs 26 has a coupling end 28. The coupling end 28 of each of the first lugs 26 has a well 30 extending into the coupling end 28, the well 30 has a bounding surface 32 and the bounding surface 32 is threaded. Additionally, the coupling end 28 is directed toward the first edge 14.

A plurality of second lugs 34 is each coupled to the drum shell 12 and each of the second lugs 34 is positioned on the outside surface 22 of the outer wall 18. The second lugs 34 are spaced apart from each other and are distributed around the outer wall 18. Each of the second lugs 34 is positioned closer to the second edge 16 than the first edge 14 and each of the second lugs 34 has a coupling end 36. The coupling end 36 of each of the second lugs 34 has a well 38 extending into the coupling end 36 of a respective second lug 34, the well 38 associated with each of the second lugs 34 has a bounding surface 40 and the bounding surface 40 of the well 38 associated with each of the second lugs 34 is threaded. Additionally, the coupling end 36 of each of the second lugs 34 is directed toward the second edge 16.

A first hoop 42 is releasably attachable to the drum shell 12 and the first hoop 42 has a plurality of first lobes 44 that each extends outwardly from the first hoop 42. Each of the first lobes 44 is distributed around a full circumference of the first hoop 42. The first hoop 42 is positionable on the first edge 14 of the drum shell 12 having each of the first lobes 44 being aligned with a respective one of the first lugs 26. Each of the first lobes 44 has a first screw hole 46 extending through the first lobes 44. A plurality of first screws 48 is each extendable through the first screw hole 46 in a respective one of the first lobes 44. Each of the first screws 48 threadably engages the bounding surface 32 of the well 30 in a respective one of the first lugs 26 for attaching the first hoop 42 to the drum shell 12.

A second hoop 50 is releasably attachable to the drum shell 12 and the second hoop 50 has a plurality of second lobes 52 each extending outwardly from the second hoop 50. Each of the second lobes 52 is distributed around a full circumference of the second hoop 50. The second hoop 50 is positionable on the second edge 16 of the drum shell 12 having each of the second lobes 52 being aligned with a respective one of the second lugs 34. Each of the second lobes 52 has a second screw hole 54 extending through the second lobes 52. A plurality of second screws 56 is each extendable through the second screw hole 54 in a respective one of the second lobes 52. Furthermore, each of the second screws 56 threadably engages the bounding surface 40 of the well 38 in a respective one of the second lugs 34 for attaching the second hoop 50 to the drum shell 12.

A drum head 58 is positionable between the second hoop 50 and the drum shell 12. The drum head 58 may be a coated drum head, a clear drum head or any other type of drum head 58. A mesh screen 60 is positionable between the first hoop 42 and the drum shell 12 and the mesh screen 60 is comprised of a fluid permeable material to pass sound through the mesh screen 60. A speaker 62 is disposed within the drum shell 12 and the speaker 62 emits audible sounds outwardly from the drum shell 12. The speaker 62 includes a mounting ring 64 extending around a perimeter of the speaker 62. The mounting ring 64 abuts the lip 24 on the inside surface 20 of the outer wall 18 of the drum shell 12 such that the speaker 62 is directed toward the mesh screen 60. The speaker 62 may be a 12.0 inch monitor speaker that is commonly employed in a public address system or the like.

A receiver 66 is coupled to the drum shell 12 and the receiver 66 is positioned on the outside surface 22 of the outer wall 18 of the drum shell 12. The receiver 66 has a distal end 68 with respect to the outside surface 22 and the distal end 68 has a well 70 extending toward the outside surface 22. Additionally, the receiver 66 includes a fastener 72 that extends laterally through the receiver 66 and intersects the well 70 in the distal end 68 of the receiver 66. An input port 74 is recessed into the outer wall 18 of the drum shell 12 and the input port 74 can be electrically coupled to a signal cord 76 from an audio source 78. The audio source 78 may be a mixing board of a public address system or other type of audio system employed for a live musical performance. Additionally, the input port 74 is electrically coupled to the speaker 62 such that the speaker 62 can emit audible sounds received from the audio source 78. The input port 74 may be a ¼ inch stereo jack, an XLR jack or other type of speaker jack commonly employed on a public address system.

A tripod 80 is provided and the tripod 80 is insertable into the receiver 66 on the drum shell 12 thereby facilitating the drum shell 12 to be elevated. In this way the drum shell 12 can be oriented to direct the speaker 62 toward a drummer 82 thereby facilitating the drummer 82 to hear audible sounds emitted by the speaker 62. Thus, the drum shell 12 can function as a monitor speaker for the drummer 82. The tripod 80 has an upper end 84 and the upper end 84 is insertable into the well 68 in the distal end 70 of the receiver 66. The fastener 72 engages the tripod 80 when the fastener 72 is tightened for retaining the tripod 80 in the receiver 66, and the fastener 72 disengages the tripod 80 when the fastener 72 is loosened for removing the tripod 80 from the receiver 66. The tripod 80 may be a telescopic tripod or other type of tripod 80 commonly employed for supporting speakers of a public address system.

In use, the drum shell 12 is mounted to the tripod 80 and the tripod 80 is adjusted to elevate the drum shell 12 to a desired height and to direct the mesh screen 60 toward the drummer 82. The signal cord 76 is plugged into the input port 74 thereby facilitating the speaker 62 to emit audible sounds toward the drummer 82. In this way the drummer 82 can hear vocals or audio from an amplified instrument, for example, during a live musical performance. Additionally, the ornamental appearance of the drum shell 12 facilitates the drum shell 12 to maintain a consistent appearance with other drum equipment.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A monitor speaker assembly having the ornamental appearance of a drum shell to facilitate the consistent appearance of drum equipment during a live musical performance, said assembly comprising:
a drum shell, said drum shell having a first edge, a second edge and an outer wall extending between said first edge and said second edge, said outer wall being continuously arcuate about a center point of said drum shell such that said drum shell has a cylindrical shape, said outer wall having an inside surface and an outside surface, said outer wall having a lip extending inwardly from said inside surface, said lip extending around a full circumference of said outer wall, said lip being positioned adjacent to said first edge;
a plurality of first lugs, each of said first lugs being coupled to said drum shell;
a plurality of second lugs, each of said second lugs being coupled to said drum shell;
a first hoop being releasably attachable to said drum shell;
a plurality of first screws, each of said first screws engaging said first hoop and a respective one of said first lugs for retaining said first hoop on said drum shell;
a second hoop being releasably attachable to said drum shell;
a plurality of second screws, each of said second screws engaging said second hoop and a respective one of said second lugs for retaining said second hoop on said drum shell;
a drum head being positionable between said second hoop and said drum shell;
a mesh screen being positionable between said first hoop and said drum shell, said mesh screen being comprised of a fluid permeable material wherein said mesh screen is configured to pass sound through said mesh screen;
a speaker being disposed within said drum shell wherein said speaker is configured to emit audible sounds outwardly from said drum shell;
a receiver being coupled to said drum shell, said receiver being positioned on said outside surface of said outer wall of said drum shell, said receiver having a distal end with respect to said outside surface, said distal end having a well extending toward said outside surface, said receiver including a fastener extending laterally through said receiver and intersecting said well;
an input port being recessed into said outer wall of said drum shell wherein said input port is configured to be electrically coupled to a signal cord from an audio source, said input port being electrically coupled to said speaker wherein said speaker is configured to emit audible sounds received from the audio source, the input port and the receiver being linearly aligned perpendicular to the first edge and the second edge; and
a tripod being insertable into said receiver on said drum shell thereby facilitating said drum shell to elevated wherein said drum shell is configured to direct said speaker toward a drummer thereby facilitating the drummer to hear audible sounds emitted by said speaker.

2. (canceled)

3. The assembly according to claim 1, wherein each of said first lugs is positioned on said outside surface of said outer wall, said first lugs being spaced apart from each other and being distributed around said outer wall, each of said first lugs being positioned closer to said first edge than said second edge, each of said first lugs having a coupling end, said coupling end of each of said first lugs having a well extending into said coupling end, said well having a bounding surface, said bounding surface being threaded.

4. The assembly according to claim 1, wherein each of said second lugs is positioned on said outside surface of said outer wall, said second lugs being spaced apart from each other and being distributed around said outer wall, each of said second lugs being positioned closer to said second edge than said first edge, each of said second lugs having a coupling end, said coupling end of each of said second lugs having a well extending into said coupling end of a respective second lug, said well associated with each of said second lugs having a bounding surface, said bounding surface of said well associated with each of said second lugs being threaded.

5. The assembly according to claim 1, wherein:
said first hoop has a plurality of first lobes each extending outwardly from said first hoop, each of said first lobes being distributed around a full circumference of said first hoop, said first hoop being positionable on said first edge of said drum shell having each of said first lobes being aligned with a respective one of said first lugs, each of said first lobes having a first screw hole extending through said first lobes; and
each of said first screws is extendable through said first screw hole in a respective one of said first lobes, each of said first screws threadably engaging said bounding surface of said well in a respective one of said first lugs for attaching said first hoop to said drum shell.

6. The assembly according to claim 1, wherein:
said second hoop has a plurality of second lobes each extending outwardly from said second hoop, each of said second lobes being distributed around a full circumference of said second hoop, said second hoop being positionable on said second edge of said drum shell having each of said second lobes being aligned with a respective one of said second lugs, each of said second lobes having a second screw hole extending through said second lobes; and
each of said second screws being extendable through said second screw hole in a respective one of said second lobes, each of said second screws threadably engaging said bounding surface of said well in a respective one of said second lugs for attaching said second hoop to said drum shell.

7. (canceled)

8. (canceled)

9. A monitor speaker assembly having the ornamental appearance of a drum shell to facilitate the consistent appearance of drum equipment during a live musical performance, said assembly comprising:
a drum shell having a first edge, a second edge and an outer wall extending between said first edge and said second edge, said outer wall being continuously arcuate about a center point of said drum shell such that said drum shell has a cylindrical shape, said outer wall having an inside surface and an outside surface, said outer wall having a lip extending inwardly from said inside surface, said lip extending around a full circumference of said outer wall, said lip being positioned adjacent to said first edge;
a plurality of first lugs, each of said first lugs being coupled to said drum shell, each of said first lugs being positioned on said outside surface of said outer wall, said first lugs being spaced apart from each other and being distributed around said outer wall, each of said first lugs being positioned closer to said first edge than said second edge, each of said first lugs having a coupling end, said coupling end of each of said first lugs having a well extending into said coupling end, said well having a bounding surface, said bounding surface being threaded;
a plurality of second lugs, each of said second lugs being coupled to said drum shell, each of said second lugs being positioned on said outside surface of said outer wall, said second lugs being spaced apart from each other and being distributed around said outer wall, each of said second lugs being positioned closer to said second edge than said first edge, each of said second lugs having a coupling end, said coupling end of each of said second lugs having a well extending into said coupling end of a respective second lug, said well associated with each of said second lugs having a bounding surface, said bounding surface of said well associated with each of said second lugs being threaded;
a first hoop being releasably attachable to said drum shell, said first hoop having a plurality of first lobes each extending outwardly from said first hoop, each of said first lobes being distributed around a full circumference of said first hoop, said first hoop being positionable on said first edge of said drum shell having each of said first lobes being aligned with a respective one of said first lugs, each of said first lobes having a first screw hole extending through said first lobes;
a plurality of first screws, each of said first screws being extendable through said first screw hole in a respective one of said first lobes, each of said first screws threadably engaging said bounding surface of said well in a respective one of said first lugs for attaching said first hoop to said drum shell;
a second hoop being releasably attachable to said drum shell, said second hoop having a plurality of second lobes each extending outwardly from said second hoop, each of said second lobes being distributed around a full circumference of said second hoop, said second hoop being positionable on said second edge of said drum shell having each of said second lobes being aligned with a respective one of said second lugs, each of said second lobes having a second screw hole extending through said second lobes;
a plurality of second screws, each of said second screws being extendable through said second screw hole in a respective one of said second lobes, each of said second screws threadably engaging said bounding surface of said well in a respective one of said second lugs for attaching said second hoop to said drum shell;
a drum head being positionable between said second hoop and said drum shell;
a mesh screen being positionable between said first hoop and said drum shell, said mesh screen being comprised of a fluid permeable material wherein said mesh screen is configured to pass sound through said mesh screen;
a speaker being disposed within said drum shell wherein said speaker is configured to emit audible sounds outwardly from said drum shell, said speaker including a mounting ring extending around a perimeter of said speaker, said mounting ring abutting said lip on said inside surface of said outer wall of said drum shell such that said speaker is directed toward said mesh screen;
a receiver being coupled to said drum shell, said receiver being positioned on said outside surface of said outer wall of said drum shell, said receiver having a distal end with respect to said outside surface, said distal end having a well extending toward said outside surface, said receiver including a fastener extending laterally through said receiver and intersecting said well;
an input port being recessed into said outer wall of said drum shell wherein said input port is configured to be electrically coupled to a signal cord from an audio source, said input port being electrically coupled to said speaker wherein said speaker is configured to emit audible sounds received from the audio source, the input port and the receiver being linearly aligned perpendicular to the first edge and the second edge; and
a tripod being insertable into said receiver on said drum shell thereby facilitating said drum shell to elevated wherein said drum shell is configured to direct said speaker toward a drummer thereby facilitating the drummer to hear audible sounds emitted by said speaker, said tripod having an upper end, said upper end being insertable into said well in said distal end of said receiver, said fastener engaging said tripod when said fastener is tightened for retaining said tripod in said receiver, said fastener disengaging said tripod when said fastener is loosened for removing said tripod from said receiver.
